(19) United States
(12) Patent Application Publication
(10) Pub. No.: US 2026/0311225 A1
(43) Pub. Date: Oct. 8, 2026

(54) Foreign E-Commerce Merchant Market Purchase and Shipping Process

(71) Applicant: John Elbaramousy Gayed, Northfield, NJ (US)

(72) Inventor: John Elbaramousy Gayed, Northfield, NJ (US)

(21) Appl. No.: 19/171,036

(22) Filed: Apr. 6, 2025

(51) Int. Cl. G06Q 30/0601; G06Q 10/0833; G06Q 10/0834

(52) U.S. Cl. CPC G06Q 30/0601; G06Q 10/0833; G06Q 10/08345

(57) ABSTRACT

Direct, foreign-e-commerce merchant market purchase and shipping process to facilitate the balance of the home and foreign country currency using existing banking payment systems and established international online marketplaces giving worldwide access to consumers with the ability to participate in international trade with sellers providing diversification and market dynamics in globalization.

### PRIOR ART

Pertaining to the transaction and shipping of products/services, Prior art includes systems and methods for online transactions using digital tokens or credits purchased, stored in the buyers “wallet.” Also, purchasing processes for international transactions using similar direct payments from buyers banking to seller's banking system. “Multi-leg” was also prior art that was compromised of a system that connected shipping companies for the purpose of optimum selection in the buyer purchase process worldwide.

### BACKGROUND OF THE INVENTION

The fore mentioned prior art described has touched on the transaction and shipping methods proving useful for the purchase and delivery of international goods in a digital marketplace howbeit have failed to offer the ability or method to purchase directly from the foreign country's online merchant. The foreign country marketplace offers products and services not available to international consumers therefore limiting the degree of flexibility in the landscape of international trade and globalization. The two-way benefit impacts buyers to a larger variety of goods and services at a lower price and sellers in the collection of foreign currency that otherwise could have gone directly to their larger counterpart's banks stiffening the flow of money down and through the ecosystem

### SUMMARY OF THE INVENTION

The Foreign E-Commerce Merchant Market Purchase and Shipping Process is an economical way to impact globalization positively. It creates the ability to move supply of home and foreign currency promoting stabilization at home and abroad through a variety of commodity access that impacts supply and demand as well. It is operated using existing banking systems and online marketplaces. As a buyer would browse through the country's local domain marketplace and select the desired product or products, a total would be available excluding shipping, this order would be taken to the nearest local international shipping company by an employee of this merchant to be quoted in local currency to the buyer's final delivery destination; the buyer is then notified or the employee unsatisfied with the current shipping price would take it to one or two more nearby international shipping companies until an appropriate price is accepted by the buyer through notification. The total is transacted through the buyer's bank using any standard form of payment available issued by the bank. The bank will convert the total of the purchase, which is in foreign currency, for their customer, to the home currency and send this to the merchant's banking account system accepting the incoming currency denomination effectively conducting international trade accessible to segments limited by restriction in travel or resource procurement.

### DETAILED DESCRIPTION OF THE INVENTION

The access of internet will allow the visit to any domain destination such as .com, .net, or .org. Furthermore, the countries will have their own domain which various websites on the world wide web use that are specific to this respective location. On it will be found online stores where products or services are bought and sold, shipped and delivered to local customers using their home currency. The Foreign E-Commerce Merchant Market Purchase and Shipping Process opens international trade enabling these goods and services to be consumed at the will of the buyer with consent of the seller for their mutual benefit.

1. A Process Compromising:
An International E-Commerce Merchant and
An International E-Commerce Customer.

2. A Process Compromising:
A Website containing the merchant's country domain specific to that location and region, and
The website is offering products and services in the merchant's local market, and
The products and services are in the merchant's market local currency.

3. A Process as in claim 2 Further Compromising:
The customer's selection of products or services.

4. A process as in claim 3 Further Consisting of:
The customer's total purchase amount is summed in the local merchant's market currency, and
Shipping is excluded, and
The merchant uses one of the local international shipping companies, and
The customer is notified of the shipping cost by the merchant, and
The total is debited from the customer in the local merchant's market currency rate, and
The total is received by the merchant as foreign currency.

5. A Process as in claim 4 Compromising:
The products or services are shipped, and
The customer is notified of the tracking information.
